(19) United States
(12) Patent Application Publication
(10) Pub. No.: US 2010/0235571 A1
(43) Pub. Date: Sep. 16, 2010

(54) STORAGE APPARATUS, RELAY DEVICE, AND METHOD FOR CONTROLLING COMMAND ISSUE

(75) Inventors: Atsushi Ishii, Kawasaki (JP); Tomoaki Tsuruta, Kawasaki (JP); Hiroaki Ochi, Kawasaki (JP); Tsukasa Makino, Kawasaki (JP); Marie Abe, Kawasaki (JP); Masanori Ito, Kawasaki (JP); Koji Ohtsuki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/720,019

(22) Filed: Mar. 9, 2010

(30) Foreign Application Priority Data
Mar. 10, 2009 (JP) 2009-55818

(51) Int. Cl. G06F 12/00

(52) U.S. Cl. 711/112; 711/E12.001

(57) ABSTRACT

A storage apparatus includes a disk controller that issues commands to disks connected in loops, and a relay device that relays the commands issued from the disk controller to the disks. The relay device includes a supervisory control unit that monitors the number of commands to be issued to each of the loops including the disks and controls the number of commands to be issued by the disk controller on the basis of the monitored results.

### CROSS-REFERENCE TO RELATED APPLICATIONS

This application is based upon and claims the benefit of priority of the prior Japanese Patent Application No. 2009-55818, filed on Mar. 10, 2009, the entire contents of which are incorporated herein by reference.

### FIELD

Various embodiments described herein relate to storage apparatuses, relay devices, and methods for controlling issue of commands.

### BACKGROUND

Connection methods for connecting targets (disks) and initiators (disk controllers) in storage apparatuses include a loop (arbitrated loop) protocol and a fabric protocol.

The loop protocol refers to a connection method in which initiators and targets are connected in sequence in a loop. Since the loop protocol allows multiple nodes to be connected to each other without using fibre channel switches, which are relatively expensive, storage area networks (SANs) can be configured at low cost. However, an increase in the number of nodes degrades performance since all of the nodes share one loop in the loop protocol.

On the other hand, the fabric protocol refers to a network using a fibre channel switch or that in which fibre channel switches are connected to each other. Since ports of initiators and those of targets are not directly connected, the fabric protocol has an excellent extensibility. Moreover, high command-processing performance can be expected compared with that of the loop protocol in which each of a plurality of targets are connected in a loop since commands are sent via only a fabric device.

Aside from these, a switching system including host devices having a function of sending frames for requesting statistical information and a plurality of fabric devices each having a function of returning the statistical information thereof in the form of frames back to the host devices in response to the frame requests and a function of switching frame transfer.

### SUMMARY

A storage apparatus includes a disk controller that issues commands to disks connected in loops and a relay device that relays the commands issued from the disk controller to the disks. The relay device includes a supervisory control unit that monitors the number of commands to be issued to each of the loops including the disks and controls the number of commands to be issued by the disk controller on the basis of the monitored results.

The object and advantages of the various embodiments will be realized and attained by means of the elements and combinations particularly pointed out in the claims.

It is to be understood that both the foregoing general description and the following detailed description are exemplary and explanatory and are not restrictive of the various embodiments, as claimed.

### BRIEF DESCRIPTION OF DRAWINGS

FIG. 1 illustrates an example configuration of a storage apparatus according to an embodiment.

FIG. 2 illustrates an example of a management table for issue of commands included in a fabric device.

FIG. 3 illustrates an example process flow of restricting the number of commands to be issued in the storage apparatus according to the embodiment.

FIG. 4 illustrates an example operation of restricting the number of commands to be issued in the storage apparatus according to the embodiment.

FIG. 5 illustrates an example process flow of removing the restriction on the number of commands to be issued in the storage apparatus according to the embodiment.

FIG. 6 illustrates an example operation of removing the restriction on the number of commands to be issued in the storage apparatus according to the embodiment.

FIG. 7 illustrates an example configuration of a storage apparatus using a combination of the fabric protocol and the loop protocol.

FIG. 8 illustrates another example configuration of a storage apparatus using a combination of the fabric protocol and the loop protocol.

### DESCRIPTION OF EMBODIMENTS

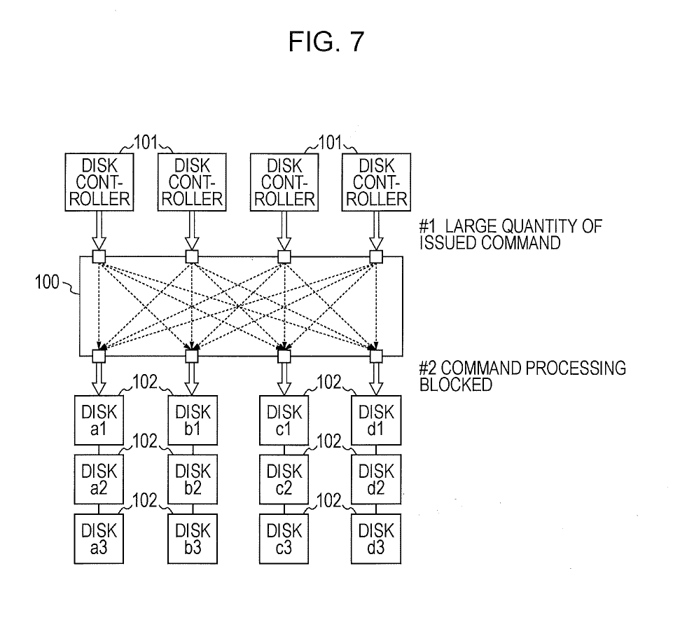

FIG. 7 illustrates an example configuration of a storage apparatus using a combination of the fabric protocol and the loop protocol. A fabric device 100 shown in FIG. 7 includes fibre channel switches (FSs; not shown in FIG. 7) connected to each other, and relays commands issued from disk controllers 101 to disks 102 via the FSs. Herein, disks a1 to a3, disks b1 to b3, disks c1 to c3, and disks d1 to d3 shown in FIG. 7 are connected to each other in a looped manner. That is, each loop shown in FIG. 7 includes three disks.

On the other hand, each of the disk controllers 101 is connected to the disk loops using the fabric protocol, and can easily issue commands to the disk loops.

Although the fabric protocol is a connection method with excellent extensibility and performance as described above, response to the commands may be degraded when the configuration of the storage apparatus grows in size and a large quantity of commands are issued from the plurality of disk controllers even when the fabric protocol is used. In the worst case, the response delay causes time-out of the commands, and it may be determined that a disk abnormality has occurred.

For example, when a large quantity of commands in excess of the performance of the disk d1 shown in FIG. 7 are issued from the disk controllers 101 to the disks 102 (see #1 in FIG. 7), transfer speed between the fabric device 100 and the disk d1 is reduced. With this, the fabric device 100 cannot process all the commands, and the command processing may be delayed (see #2 in FIG. 7).

In order to prevent the command processing from being blocked in the fabric device 100 due to the issue of the large quantity of commands, the number of commands each of the disk controllers 101 can issue at one time can be restricted in units of disks in accordance with the performance of the disks (restriction method compatible with the disk performance). When the number of commands each of the disk controllers 101 issues at one time exceeds the limit in the restriction method, the disk controllers put the commands in queues so that a large quantity of commands are not sent to the fabric device 100. The commands are put in queues in units of disks since the performance of the disks 102 connected to the fabric device 100 vary from each other. When a large number of commands are issued to the disks 102 with low performance, response delay occurs while the commands are processed in the disks 102. Therefore, in order to control the number of commands to be issued to each disk in accordance with the performance of the disk, an upper limit is set for the number of commands to be issued to each disk 102 in accordance with the performance of the disk 102, and the number of commands to be issued is controlled so as not to exceed the upper limit in the restriction method.

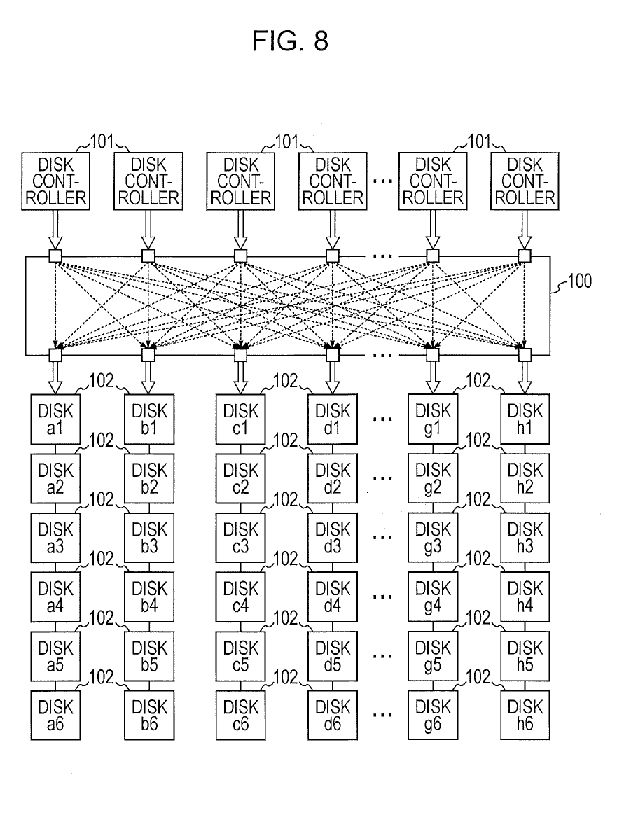

However, for example, as shown in FIG. 8, when the configuration of the storage apparatus grows in size and the number of disks 102 in each loop is increased, control of the number of commands to be issued according to the restriction method cannot prevent the delay of the command processing in the fabric device 100, and as a result, command response is degraded. When the number of the disks 102 connected in loops is increased, that is, the total number of the disks 102 connected to the fabric device 100 is increased, the number of commands issued to specific disks 102 is increased to such an extent that the fabric device 100 cannot process all the commands even when the disk controllers 101 restrict the number of commands to be issued in units of disks.

Furthermore, the method in which each of the disk controllers controls the number of commands to be issued has the following problem. For example, it is hypothesized that each of the disk controllers included in the storage apparatus issues commands up to a predetermined threshold for issue of commands. Herein, a value obtained by dividing the number of commands a fabric device can accept by the number of the disk controllers is set to the command-issue threshold. When the number of the disk controllers is four, for example, the command-issue threshold is set to a quarter of the number of commands the fabric device can accept. When a disk controller on which loads are concentrated issues commands up to the command-issue threshold, which is a quarter of the number of commands the fabric device can accept, while the three disk controllers other than that on which the loads are concentrated do not issue any commands, the fabric device processes only a quarter of commands the device can process. As a result, the issue of commands cannot be optimally controlled in the entire system.

Therefore, in order to optimally control the issue of commands in the entire system, the number of commands a relay device typified by the fabric device processes needs to be balanced and the relay device needs to process the commands in accordance with its processing capability even when loads are concentrated on a specific disk controller. To this end, the relay device controls the issue of commands issued from each of the disk controllers instead of each of the disk controllers controlling the number of commands to be issued using a predetermined threshold (for example, a value obtained by dividing the number of commands a fabric device can accept by the number of the disk controllers).

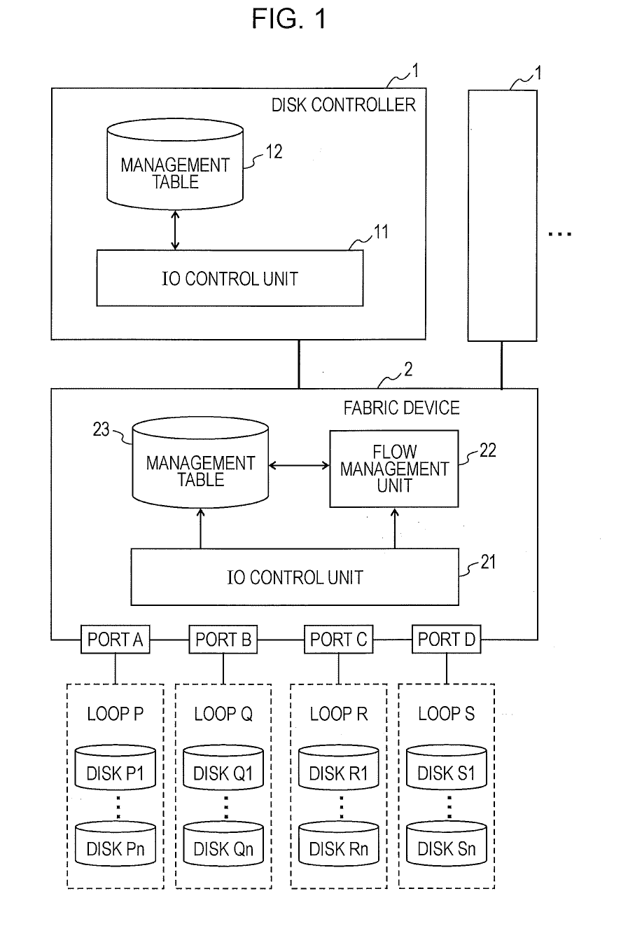

FIG. 1 illustrates an example configuration of a storage apparatus according to this embodiment. The storage apparatus according to this embodiment includes a plurality of disk controllers 1 and a fabric device 2. The disk controllers 1 issue commands to disks connected in loops using predetermined interfaces. In the example shown in FIG. 1, disks P1 to Pn connected in a loop constitute a loop P, and disks Q1 to Qn connected in a loop constitute a loop Q. Moreover, disks R1 to Rn connected in a loop constitute a loop R, and disks S1 to Sn connected in a loop constitute a loop S. The fabric device 2 has a function of being a relay device that relays commands issued from the disk controllers 1 to the disks serving as targets for the commands. In the example shown in FIG. 1, the loop P is connected to a port A included in the fabric device 2, the loop Q is connected to a port B, the loop R is connected to a port C, and the loop S is connected to a port D. The loops receive commands relayed by the fabric device 2 via the respective ports to which the loops are connected.

The disk controllers 1 each include an input/output (10) control unit 11 and a management table 12 for issue of commands. The IO control units 11 issue commands to the disks. Moreover, the IO control units 11 restrict (for example, suspend) the issue of commands to the disks included in specified loops in accordance with instructions issued from a flow management unit included in the fabric device 2. The number of commands issued to each of the loops connected to the corresponding port included in the fabric device 2 is set in the management tables 12 for each port.

The fabric device 2 receives commands issued by the IO control units 11 of the disk controllers 1, and relays the commands to the loops in which the disks serving as the targets for the commands are included. The fabric device 2 includes an IO control unit 21, the flow management unit 22, and a management table 23 for issue of commands.

The IO control unit 21 receives commands from each of the IO control units 11 of the corresponding disk controller.

Moreover, the IO control unit 21 makes an inquiry to the flow management unit 22 as to whether or not the commands can be sent to the port corresponding to (connected to) the target for the commands (hereinafter referred to as the target port). The flow management unit 22 receives the inquiry from the IO control unit 21, and determines whether or not the number of commands to be issued to the target port, that is, the number of commands to be issued to the loop including the target disk exceeds a predetermined threshold by referring to the management table 23. When the flow management unit 22 determines that the number of commands to be issued to the target port exceeds the predetermined threshold, the flow management unit 22 issues instructions to the IO control unit 11 of the disk controller 1 that has issued the commands to restrict the issue of commands to the loop including the target disk. That is, the IO control unit 21 and the flow management unit 22 have a function of being supervisory control unit that monitors the number of commands to be issued by each of the disk controllers 1 to the loop including the target disk and controls the number of commands to be issued by the disk controller 1 on the basis of the monitored results.

Moreover, the flow management unit 22 determines whether or not the number of commands to be issued to the loop to which the issue of commands is restricted is lower than or equal to the threshold by referring to the management table 23. When the flow management unit 22 determines that the number of commands to be issued to the loop to which the issue of commands is restricted is lower than or equal to the threshold, the flow management unit 22 issues instructions to the IO control unit 11 of the disk controller 1 that has issued the commands to remove the restriction on the issue of commands to the loop. The management table 23 includes the number of commands to be issued for each of the target ports.

In the storage apparatus according to this embodiment shown in FIG. 1, the fabric device 2 monitors the numbers of commands to be issued in units of disk loops, and controls the number of commands to be issued by the disk controllers 1 for each of the target ports on the basis of the monitored results. Therefore, even when loads are concentrated on a specific disk controller among the plurality of disk controllers 1 connected to the fabric device 2 and a large number of commands are issued from this specific disk controller, the number of commands the fabric device 2 processes can be balanced and the fabric device can process the commands within its processing capability. As a result, the issue of commands can be optimally controlled in the entire system.

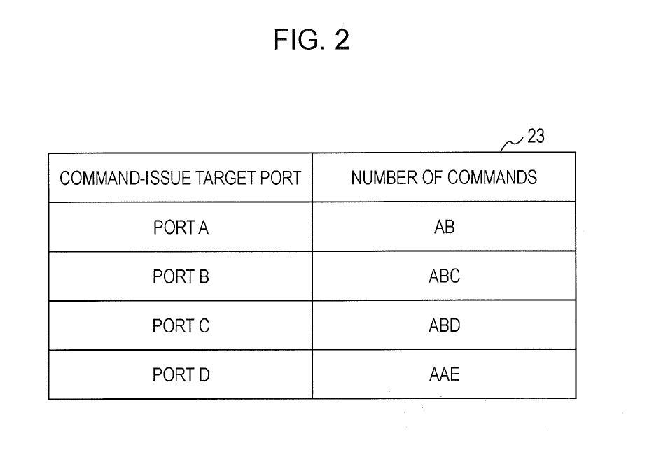

FIG. 2 illustrates an example of the management table included in the fabric device. In the example shown in FIG. 2, correspondence information between the target ports and the numbers of commands to be issued to the loops of the disks via the respective target ports is set in the management table 23. Herein, the management tables 12 included in the respective disk controllers 1 have a structure similar to that of the management table 23 shown in FIG. 2.

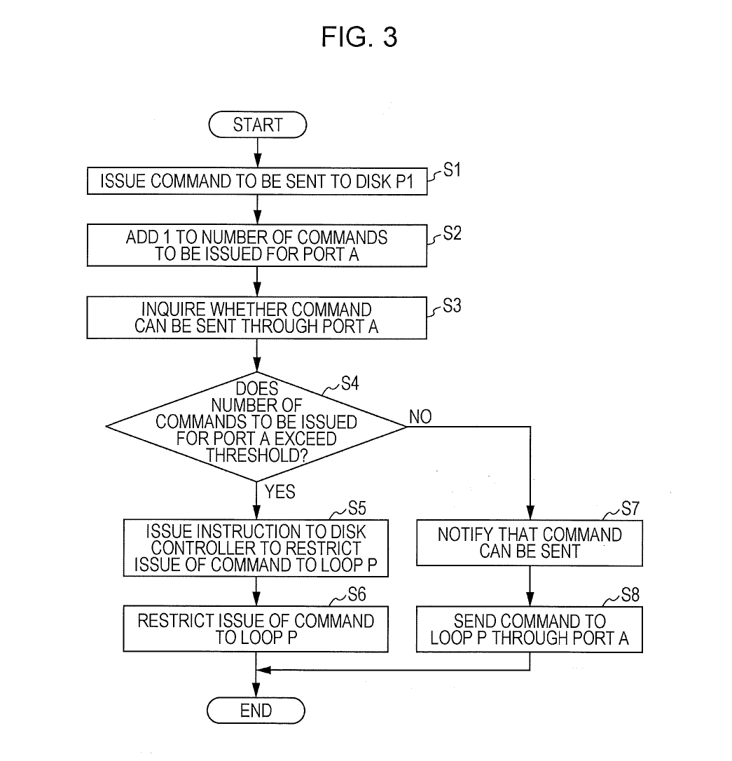

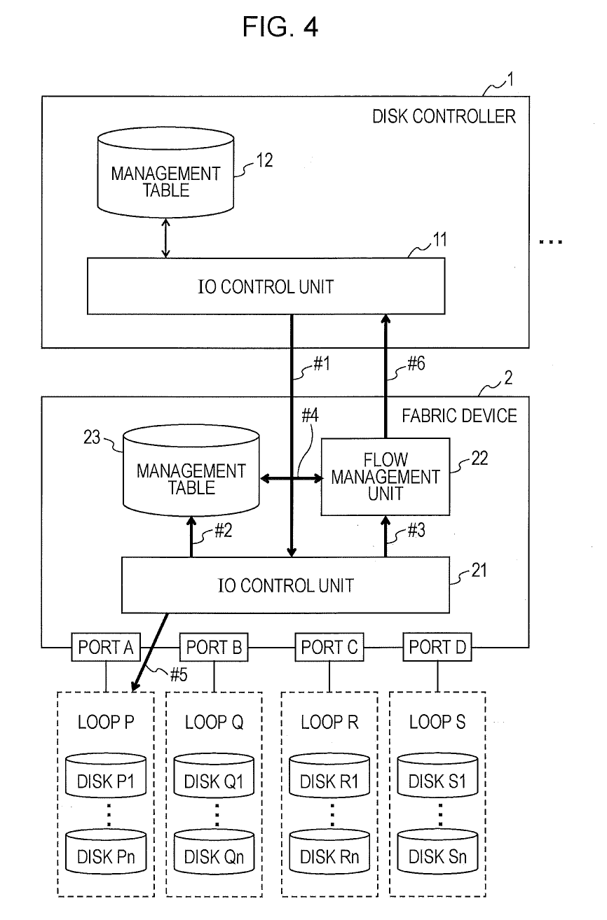

FIG. 3 illustrates an example process flow of restricting the number of commands to be issued in the storage apparatus according to this embodiment. Moreover, FIG. 4 illustrates an example operation of restricting the number of commands to be issued in the storage apparatus according to this embodiment.

First, the IO control unit 11 of a disk controller 1 issues a command to be sent to the disk P1 to the IO control unit 21 of the fabric device 2 (see Step S1 in FIG. 3 and #1 in FIG. 4). In the example shown in FIG. 4, the target port is the port A. Thus, the IO control unit 11 adds one to the number of issued commands for the port A set in the management table 12.

Next, the IO control unit 21 of the fabric device 2 adds one to the number of commands to be issued for the port A set in the management table 23 (see Step S2 in FIG. 3 and #2 in FIG. 4). Subsequently, the IO control unit 21 makes an inquiry to the flow management unit 22 as to whether or not the command can be sent through the port A (see Step S3 in FIG. 3 and #3 in FIG. 4). The flow management unit 22 refers to the management table 23, and determines whether or not the number of commands to be issued for the port A exceeds a predetermined threshold (see Step S4 in FIG. 3 and #4 in FIG. 4). When the flow management unit 22 determines that the number of commands to be issued for the port A does not exceed the predetermined threshold, the flow management unit 22 notifies the IO control unit 21 that the command can be sent (see Step S7 in FIG. 3). The IO control unit 21 sends the command to the loop P through the port A (see Step S8 in FIG. 3 and #5 in FIG. 4).

When the flow management unit 22 determines that the number of commands to be issued for the port A exceeds the predetermined threshold, the flow management unit 22 notifies the IO control unit 21 that the command cannot be sent, and issues instructions to the IO control unit 11 of the disk controller 1 to restrict the issue of commands to the loop P (see Step S5 in FIG. 3 and #6 in FIG. 4). The IO control unit 11 of the disk controller 1 restricts the issue of commands to the loop P (see Step S6 in FIG. 3).

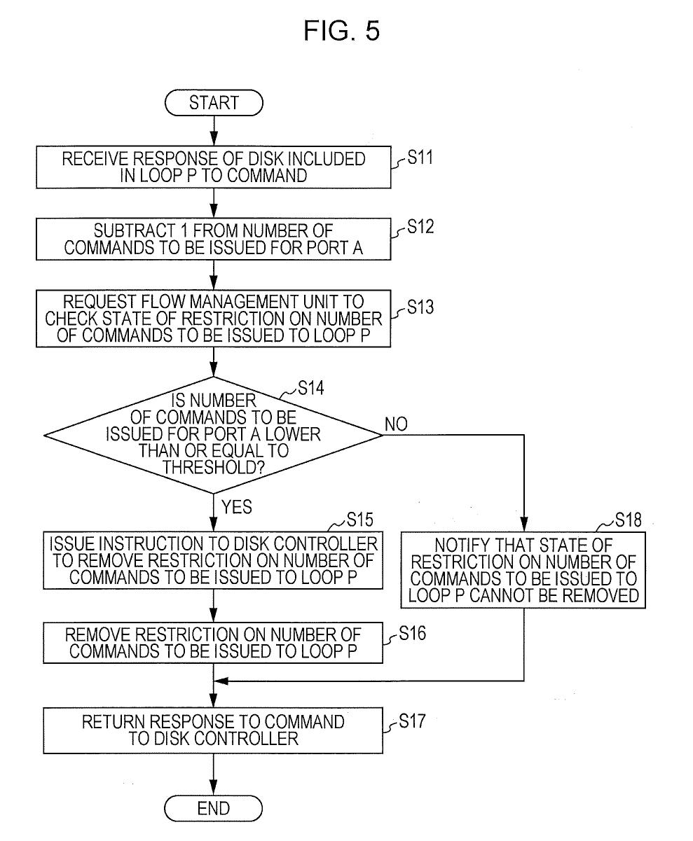

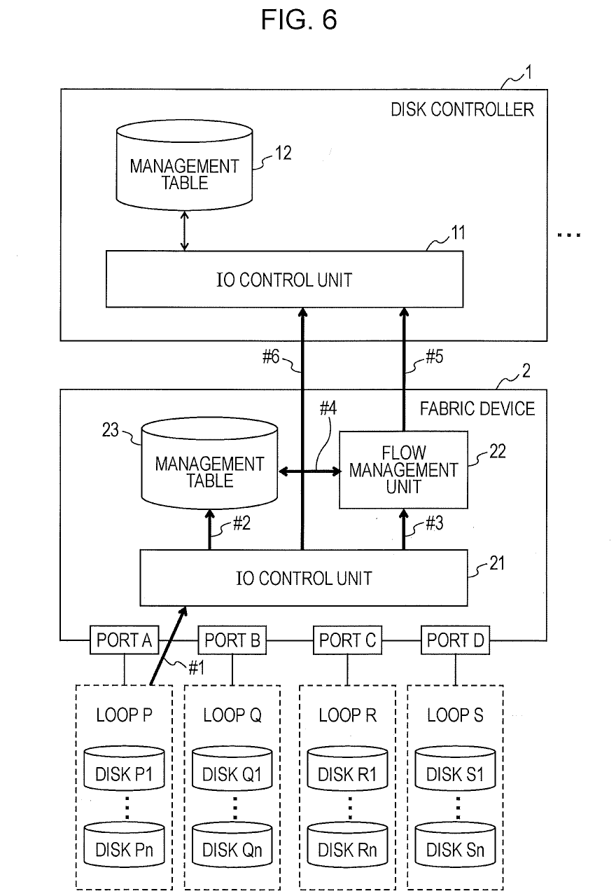

FIG. 5 illustrates an example process flow of removing the restriction on the number of commands to be issued in the storage apparatus according to this embodiment. Moreover, FIG. 6 illustrates an example operation of removing the restriction on the number of commands to be issued in the storage apparatus according to this embodiment. In the example shown in FIGS. 5 and 6, it is assumed that the issue of commands to the loop P has been already restricted in the storage apparatus.

First, the IO control unit 21 of the fabric device 2 receives a response of the disk included in the loop P to the command through the port A (see Step S11 in FIG. 5 and #1 in FIG. 6). Next, the IO control unit 21 subtracts one from the number of commands to be issued for the port A set in the management table 23 (see Step S12 in FIG. 5 and #2 in FIG. 6). Subsequently, the IO control unit 21 requests the flow management unit 22 to check the restriction state of the number of commands to be issued to the loop P (see Step S13 in FIG. 5 and #3 in FIG. 6).

The flow management unit 22 refers to the management table 23, and determines whether or not the number of commands to be issued to the loop P (the number of commands to be issued for the port A) is lower than or equal to the predetermined threshold (see Step S14 in FIG. 5 and #4 in FIG. 6). When the flow management unit 22 determines that the number of commands to be issued to the loop P is not lower than or equal to the predetermined threshold, the flow management unit 22 notifies the IO control unit 21 that the state of restricting the number of commands to be issued to the loop P cannot be removed (see Step S18 in FIG. 5), and the process proceeds to Step S17. When the flow management unit 22 determines that the number of commands to be issued to the loop P is lower than or equal to the predetermined threshold, the flow management unit 22 notifies the IO control unit 21 that the state of restricting the number of commands to be issued to the loop P can be removed, and issues instructions to the IO control unit 11 of the disk controller 1 to remove the restriction on the number of commands to be issued to the loop P (see Step S15 in FIG. 5 and #5 in FIG. 6). The IO control unit 11 removes the restriction on the number of commands to be issued to the loop P (see Step S16 in FIG. 5). Subsequently, the IO control unit 21 of the fabric device 2 returns a response to the command to the IO control unit 11 of the disk controller 1 (see Step S17 in FIG. 5 and #6 in FIG. 6).

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. The media described above are non-transitory media.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

1. A storage apparatus, comprising:
a disk controller that issues commands to disks connected in loops; and
a relay device that relays the commands issued from the disk controller to the disks, wherein
the relay device includes a supervisory control unit that monitors a number of commands to be issued to each of the loops including the disks and controls a number of commands to be issued by the disk controller based on the monitored results.

2. The storage apparatus according to claim 1, wherein
the supervisory control unit included in the relay device determines whether or not the number of commands to be issued to a loop, among the loops, including the disk to which the commands are issued exceeds a predetermined threshold, and issues instructions to the disk controller to restrict the issue of commands to the loop when it is determined that the number of commands to be issued exceeds the predetermined threshold.

3. The storage apparatus according to claim 2, wherein
the supervisory control unit included in the relay device issues instructions to the disk controller to remove the restriction on the number of commands to be issued to the loop when it is determined that the number of commands to be issued to the loop to which the issue of commands is restricted is lower than or equal to the predetermined threshold.

4. A relay device for relaying commands to disks connected in loops, the commands being issued from a disk controller to the disks, the device comprising:
a supervisory control unit that monitors a number of commands to be issued to each of the loops including the disks and controls a number of commands to be issued by the disk controller on the basis of the monitored results.

5. The relay device according to claim 4, wherein
the supervisory control unit determines whether or not the number of commands to be issued to a loop, among the loops, including the disk to which the commands are issued exceeds a predetermined threshold, and issues instructions to the disk controller to restrict the issue of commands to the loop when it is determined that the number of commands to be issued exceeds the predetermined threshold.

6. The relay device according to claim 5, wherein
the supervisory control unit issues instructions to the disk controller to remove the restriction on the number of commands to be issued to the loop when it is determined that the number of commands to be issued to the loop to which the issue of commands is restricted is lower than or equal to the predetermined threshold.

7. A method for controlling issue of commands in a storage apparatus including a disk controller that issues commands to disks connected in loops and a relay device that relays the commands issued from the disk controller to the disks, the method comprising:
monitoring a number of commands to be issued to each of the loops including the disks and controlling a number of commands to be issued by the disk controller on the basis of the monitored results using the relay device.

8. The method for controlling issue of commands according to claim 7, wherein
the relay device determines whether or not the number of commands to be issued to a loop, among the loops, including the disk to which the commands are issued exceeds a predetermined threshold, and issues instructions to the disk controller to restrict the issue of commands to the loop when it is determined that the number of commands to be issued exceeds the predetermined threshold during monitoring and controlling.

9. The method for controlling issue of commands according to claim 8, wherein
the relay device issues instructions to the disk controller to remove the restriction on the number of commands to be issued to the loop when it is determined that the number of commands to be issued to the loop to which the issue of commands is restricted is lower than or equal to the predetermined threshold during monitoring and controlling.
